(19) United States
(12) Patent Application Publication
(10) Pub. No.: US 2008/0247051 A1
(43) Pub. Date: Oct. 9, 2008

(54) Variable Lens

(75) Inventors: Bernardus H.W. Hendriks, Eindhoven (NL); Stein Kuiper, Vught (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,331

(22) PCT Filed: Mar. 24, 2005
(86) PCT No.: PCT/IB2005/051014

§ 371 Date: Sep. 26, 2006

(30) Foreign Application Priority Data
Mar. 30, 2004 (GB) 0407231.0

(51) Int. Cl. G02B 3/14

(52) U.S. Cl. 359/666

(57) ABSTRACT

A variable lens (20) of electrowetting type comprise a fluid chamber (22) including a first, electrically conductive, fluid (40) and a second, nonconductive, fluid (50) and further comprises a first electrode (34) connected to the first liquid and second electrode means (30,32) arranged on the inner side of the chamber wall (24), whereby a volume of one of the fluids is arranged between two volumes of the other fluid. The lens can be driven by a low voltage applied between the first electrode and the second electrode and has relatively high optical power, due to the two interfaces between the fluids.

The invention relates to a variable lens comprising;

a substantially cylindrical chamber having a cylinder wall and including a first, electrically conductive, fluid and a second, non-conductive fluid, the fluids being non-miscible in contact with each other and having different indices of refraction, and
an electrode configuration comprising a first electrode in contact with the first fluid and second electrode means arranged on the chamber wall

The invention also relates to a camera comprising such a variable lens.

A variable lens is understood to mean a lens in which one or more properties of the lens can be controllably adjusted, e.g. of which the focal length or the position of optically active elements can be altered. A fluid is understood to mean a substance that alters its shape in response to any force, that tends to flow or to conform to the outline of its chamber, and that includes gases, liquids and mixtures of solids and liquids capable of flow.

DE 19710668 describes a variable lens, which comprises a resilient membrane filled with a fluid. The pressure of the fluid within the membrane, which forms a refractive surface of the lens is controlled by means of a pump and determines the curvature of the membrane. The optical power of the lens is determined by the curvature of the membrane and the ratio of the refractive indices of fluid within the membrane and that of the medium at the outside of the membrane. By varying the pressure the curvature of the membrane and thus the optical power of the lens can be changed.

Such a lens system poses a number of disadvantages. Due to the change of the curvature of the membrane, it is difficult to maintain good optical properties. Further the lens system is susceptible to mechanical fatigue. Control of the shape of the membrane, i.e. the refractive surface, is not only dependent upon the pressure of the fluid, but also the resilience of the membrane. Consequently, obtaining a desired range of desired membrane shapes and thus of focal lengths, can be problematic, particularly if the elasticity of the membrane changes over time. Further, flexible membranes normally are not gas tight, resulting in the evaporation of the fluid from the device over time.

Variable focus lenses based on electrowetting devices are also known. Electrowetting devices are devices that utilise the electrowetting phenomenon to operate. In electrowetting the three phase contact angle, i.e. the angle between the contact surface of two liquids and a solid surface, e.g. a chamber wall, is changed with applied voltage.

International patent application WO 03/069380 describes a variable focus lens utilising the electrowetting effect. This lens has two immiscible liquids confined in a sealed space, i.e. a chamber or cavity. The term immiscible indicates that the fluids do not mix. The first fluid is electrically conductive, e.g. water containing a salt solution, and the second fluid is electrically insulating, silicone oil. The first and second fluids have different refractive indices. The first fluid is in contact with a first electrode and a second electrode is arranged at the inner side of the chamber wall and may be separated from the first liquid by an insulating layer. Voltage from a voltage supply can be applied between the two electrodes. By varying this voltage the shape of the interface, i.e. a meniscus, between the first fluid and the second fluid is altered so as to change the lens function provided by the interface.

Although this electrowetting lens provides a great progress in the field of compact and easily controllable lenses, it still poses a number of disadvantages. The configuration requires a relatively high voltage to alter the shape of the interface of the two liquids. Requirements have to be set to the liquids, which results in a relatively small ratio of the refractive indices of the liquids that can be used, which means that the lens power is relatively small. Deformation of the interface, which is needed for focus variation, influences the optical quality of the lens. Moreover, as is also the problem with fixed focus lenses, if it is desirable to maintain the same lens shape, but simply alter the position of the lens, then the complete device must be mechanically moved, e.g. by expensive actuators. Such movement can be difficult to control accurately and can be susceptible to vibrations and mechanical wear and tear.

It is an object of the present invention to solve this problem and to provide a variable lens that has a high optical power, which focus can be varied by means of very low voltage. The lens according to the invention is characterized in that

a volume of one of the fluids is arranged between two volumes of the other fluid, in that

the second electrode means comprises at least two sub-electrodes each covering, in the direction of the cylinder axis, different portions of the cylinder wall, and in that

the chamber wall is provided with two openings at its opposite ends which are interconnected by means of an external fluid guide to circulate one of the fluids in and out the chamber.

In the fluid chamber one of the fluids is at two opposite sides embedded by the other fluid, or in other words a volume, which may be called a slug, of one of the liquids is positioned between two volumes of the other fluid. Consequently the chamber comprises two liquid-to-liquid interfaces, or menisci, which means that there are two refractive surfaces. The new lens thus can have an optical power that is twice the optical power of the known electrowetting lens. In a neutral state the slug is positioned symmetrically with respect to the sub-electrodes of the second electrode and the two interface surfaces show the same surface tension. As soon as the surface tension of one of the interfaces becomes different from the surface tension of the other interface, the slug starts to move in the direction of the chamber cylinder axis, which is the optical axis of the lens. A small difference in tension suffices to start the movement. The tension difference is evoked by applying a voltage to one of the sub-electrodes, which accomplishes a change in the curvature of the interface at the side of this sub-electrode and consequently a change in the surface tension at that interface. Only a very low voltage, only a few Volts, is needed to accomplish the required curvature change and thus the required surface tension difference.

The slug moves in the direction of the activated sub-electrode and keeps moving until the voltage is switched of or the slug reaches an end wall of the chamber.

Instead of by changing the shape of a refractive surface, the focus of the present lens is varied by moving the slug. This is similar to movement of a conventional lens for the same purpose, however without using an actuator. Since the deformation of the refractive interfaces is very small, the optical quality of the present lens is substantially better than that of a lens wherein focus variation is realised by deforming a refractive interface. Since the driving voltage is low, lesser requirements have to be set to the fluids so that fluids can be chosen, which have largely different refractive indices. Also along this way the power of the lens can be increased with respect to a known electrowetting lens.

The variable lens is further characterized in that the inner wall of the fluid chamber facing the fluids is covered with an insulating layer.

This layer separates the first fluid from the second electrode means.

Preferably, the variable lens is further characterized in that the insulating layer is hydrophobic.

This layer prevents that fluid sticks to the inner wall at undesired positions.

A first embodiment of the variable lens is characterized in that a volume of the first fluid is arranged between volumes of second fluid.

A second embodiment of the variable lens is characterized in that a volume of the second fluid is arranged between volumes of the first fluid.

This embodiment is preferably further characterized in that the first electrode is arranged substantially in one of the openings in the chamber wall.

In this way it is ensured that the first electrode always reach in the first fluid.

A specific embodiment of the variable lens is characterized in that the second electrode means comprises a series of annular electrodes

This embodiment is very suitable to be used as a zoom lens or in a zoom lens system.

A practical embodiment of the variable lens is characterized in that the fluids are liquids.

This embodiment may be further characterized, characterized in that the first liquid is salted water and the second liquid is oil.

These liquids have proven their advantages for use in electrowetting lenses.

In a specific embodiment the variable lens is a zoom lens.

The variable lens may be used in an image-capturing device comprising a lens system and an image-receiving unit. This device is characterized in that the lens system comprises a variable lens as described herein before.

This image-capturing device is very suitable for use in a camera, especially a miniature camera.

The lens system of this camera may be a zoom lens system.

This camera may be incorporated in a hand-held apparatus, so that also such apparatus comprising the camera forms part of the invention.

Such hand-held apparatus is for example a mobile phone.

The invention may also be used in an optical device for scanning an information layer and comprising a radiation source unit for supplying a scanning beam, an optical lens system for focusing the scanning beam to a scanning spot in the information layer and a radiation-sensitive detection unit for converting scanning beam radiation from the information layer in electrical signals, This device is characterized in that the lens system comprises a variable lens as described herein before.

This device when used for scanning at least two information layers at different depths in one record carrier and comprising an objective lens system and a collimator lens system, may be characterized in that the variable lens is included in the collimator lens system to correct for spherical aberrations introduced by the different depths of the information layers.

A device for scanning at least two information layers of different format, wherein the radiation source unit is switchable to emit at least two beams of different wavelengths and wherein the lens system comprises an objective lens system, may be characterized in that the variable lens is included in the objective lens system to adapt this system for the different formats of the information layers.

These and other aspects of the invention will be apparent from and elucidated by way of non-limitative example, with reference to the embodiments described hereinafter. In the drawings:

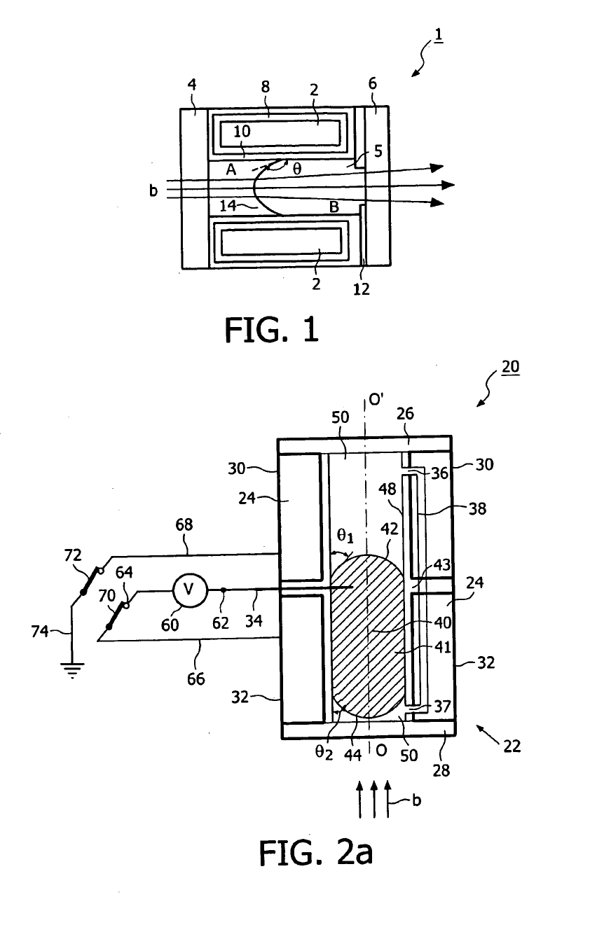

FIG. 1 shows the principle of a known electrowetting lens;

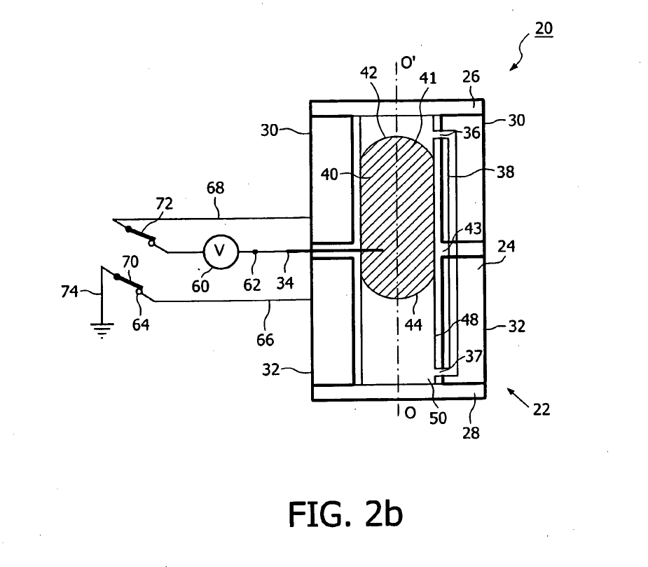

FIGS. 2a and 2b show a first embodiment of a lens according to the invention in a first state and a second state, respectively;

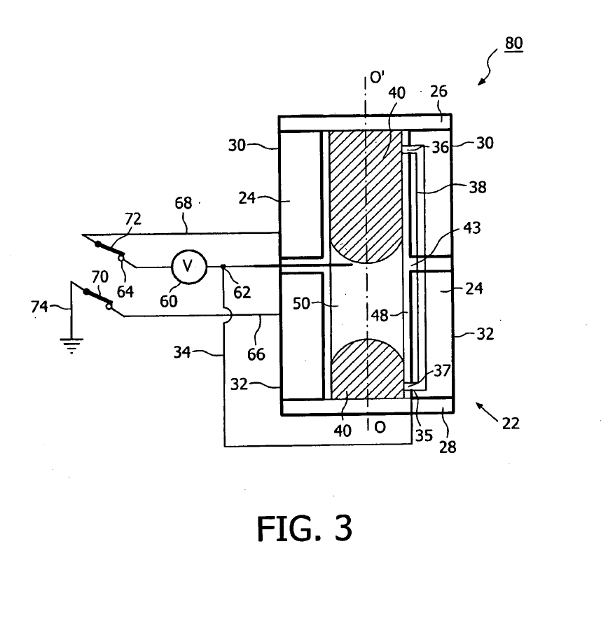

FIG. 3 shows a second embodiment of this lens;

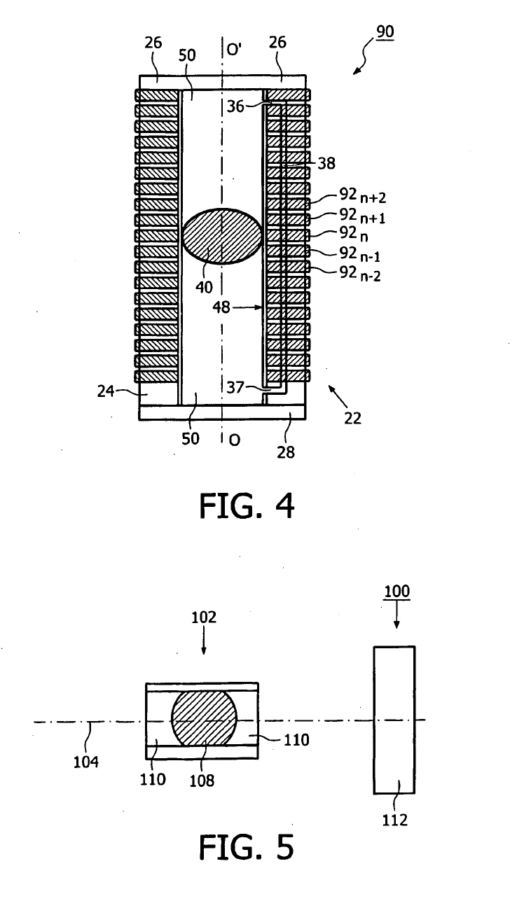

FIG. 4 shows a third embodiment of the lens;

FIG. 5 shows a schematic diagram of a camera including a lens according to the invention;

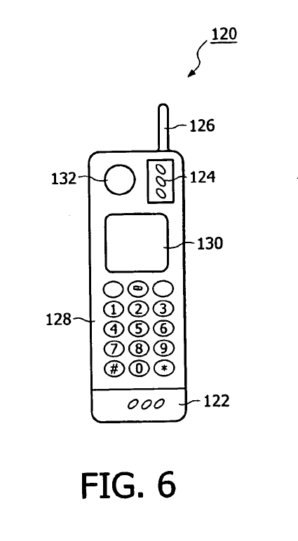

FIG. 6 shows a mobile phone including such a camera, and

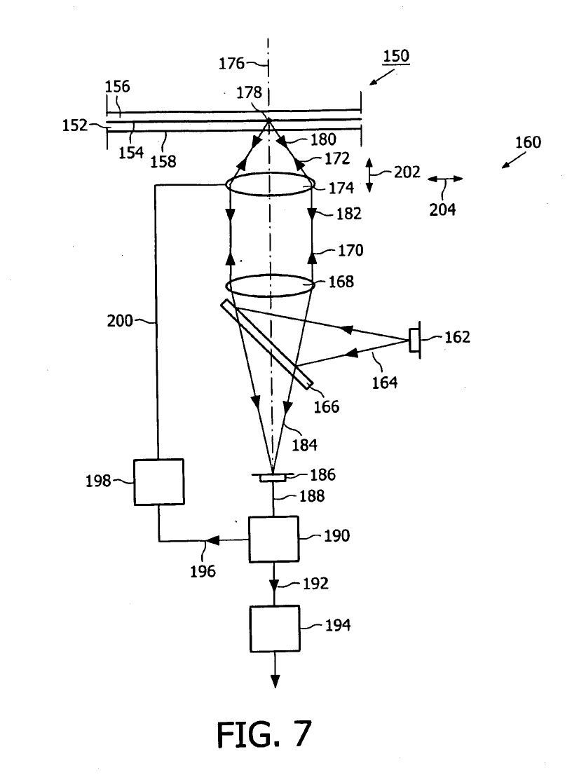

FIG. 7 shows an optical device for reading an optical record carrier and including a lens according to the invention.

Known lens 1, shown in FIG. 1 comprises a cylindrical first electrode 2 forming a capillary tube, sealed by means of a transparent front element 4 and a transparent back element 6 to form a fluid chamber 5 containing two fluids. The electrode 2 may be an electrically conducting coating applied on the inner wall of the tube.

The two fluids consist of two non-miscible liquids in the form of an electrically insulating first liquid A, such as a silicone oil or an alkane, referred to herein further as “the oil” and an electrically conducting second liquid B, such as water containing a salt solution. The two liquids preferably have equal density so that the lens functions independently of orientation, i.e. without dependence on gravitational effects between the liquids. The liquids are chosen such that the first liquid A has a higher refractive index than the second liquid B.

The electrode 2 is coated by an electrically insulating layer 8, for example of parylene. This layer is coated with a hydrophobic layer 10, which prevents sticking of the fluid to the chamber wall.

A second, annular, electrode 12 is arranged adjacent the back element 6 with at least one portion in the fluid chamber such that this electrode acts on the second fluid B.

The two fluids A and B are non-miscible so as to tend to separate into two fluid bodies, or volumes, separated by an interface 14 in the form of a meniscus. If no voltage is applied between the first and second electrodes the hydrophobic layer has a higher wettability with respect to the first fluid A than with respect to fluid B. Due to electrowetting, the wettability by the second fluid B varies under the application of a voltage between the first electrode and the second electrode, which tends to change the contact angle θ of the meniscus at the three phase line, i.e. the line of contact between the hydrophobic layer 10 and the two liquids A and B. The shape of the meniscus 14 and consequently the focus of the lens, is thus variable in dependence on the applied voltage.

Dependent on the required focus change, this voltage should have, for example, values between some tens and 200 Volt, which renders this lens lesser suitable for application in hand-held apparatus. Moreover liquids, which are suitable for use as liquid A and liquid B have a relatively low refractive index difference, which limits the optical power of the lens.

The lens according to the present invention does not show such deficiencies. This lens uses also electrowetting, however not for deforming a meniscus, but for initiating a movement of the menisci which movement is maintained by a difference in the surface tensions of the two menisci.

FIGS. 2a and 2b show a cross-section of a first embodiment of the lens according to the invention

In a first state and a second state, respectively. The lens comprises two fluids 40 and 50, for example liquids, which are immiscible and have different refractive indices. Fluid 40 is electrically conductive and comprises, for example, water and fluid 50 is electrically insulating and comprises for example oil. In this embodiment a volume, or slug, of fluid 40 is arranged between two volumes of fluid 50 so that the lens comprises two interfaces 42 and 44 between materials of different refractive index, which interfaces have a meniscus shape. This lens can be compared with a solid lens having two refractive surfaces, which in this case are convex. Such a lens may have a large lens power and allows focussing of a light beam b.

The fluids are contained in a fluid chamber 22. In this embodiment the chamber takes the form of a longitudinally extended tube defined by sidewall 124 and having a tube axis. In this particular example, the chamber is a circularly cylindrical tube and the optical axis OO′ is co-axial with the tube axis. Additional walls 26 and 28 extend across the ends of the tube so as to form a chamber 22 enclosing the fluids. At least the portions of the walls 26, 28 lying is around the optical axis OO′ are transparent.

The menisci 42 and 44 between the two fluids extend transverse the optical axis OO′ of the lens 20. The term transverse indicates that the menisci cross, i.e. extends across, the optical axis and is not parallel to the optical axis. The menisci may cross the optical axis at any desired angle. The perimeter of the menisci 42 and 44 are defined by the sidewall of the chamber.

Typically, in order to locate the fluids 40 and 50 within the desired portion of the chamber 22, different areas of the chamber will have different wettabilities for each fluid, such as each fluid will be attracted by a respective area. Wettability is the extent by which an area is wetted, i.e. covered, by a fluid. For instance, if the fluid 40 is an electrically conductive, polar, fluid and the fluid 50 is a non-conductive flood, then the internal surface of the wall 24 may be hydrophilic so as to attract the fluid 40 and not attract fluid 50.

The shape of the menisci 42 and 44 is determined by the contact angle θ of the meniscus edge with the internal surface of the fluid chamber's wall. Hence the meniscus shape is determined by the wettability of this surface. In this lens the menisci shapes are nearly constant. The menisci shapes illustrated are convex, as viewed from the fluid 40, but may also be concave.

The lens 20 further comprises a first electrode 34, which reaches in the first fluid 40 and is permanently connected to a first output 62 of a voltage source 60. A second electrode means is arranged on the wall 24 of the chamber. In this embodiment the second electrode means comprises a first sub-electrode and a second sub-electrode 30 and 32 respectively, which each may occupy nearly one half of the cylinder length. These electrodes are separated from each other by gap 43. Sub-electrode 30 may be connected tot the second output 64 of the voltage source 60 via a conductor 68 and a switch 72 and sub-electrode 32 may be connected to the second output via a conductor 66 and a switch 70.

The whole inner side of the chamber wall, both the sub-electrodes 30 and 32 and the gap 43 may be covered by an insulating layer and this layer may be covered by a hydrophobic layer, similar to the lens shown in FIG. 1. As an alternative, a layer 48 covers the inner side of the chamber wall, which is both insulating and hydrophobic, as shown in FIGS. 2a and 2b. In a neutral state of the lens no voltage is applied to the sub-electrodes 30 and 32, i.e. conductors 66 and 68 are connected via switches 70 and 72 to ground electrode. The volume 41, also called slug, of first fluid is then in the length direction positioned symmetrically with respect to the sub-electrodes 30 and 32. The surface tension of the interfaces 42 and 44 are equal, these interfaces have the same curvature and the same contact angle θ and the slug 41 is stationary.

If sub-electrode 32 is connected via switch 70 to the second output 64 of voltage source 60, i.e. if a voltage is applied between this sub-electrode and the first electrode 34, the sub-electrode 32 generates electrowetting forces. The hydrophobic layer 48 at the position of this sub-electrode becomes hydrophilic. The forces cause a small change in the contact angle θ₂ of the interface 44, which is at that moment situated in the range of sub-electrode 32. As a consequence a small change in the curvature of the interface 44 occurs. The contact angle θ₁ of the interface 42 still has its initial value and this interface still has its initial curvature. According to Laplace's law, the pressure inside the fluids is dependent on the curvature of the interface between the fluids. As a consequence of their different curvatures, the interfaces 42 and 44 have different surface tensions. Due to this difference in surface tensions the slug 41 starts to move towards the activated sub-electrode 32. This movement will go on as long as the voltage between electrodes 32 and 34 is maintained or until the slug reaches the lower wall 28 of the chamber. If the voltage between the sub-electrode 32 and the first electrode 34 is switched off, the slug 41 will maintain the position it has reached then.

FIG. 2a shows the situation that the slug has nearly reached the lower wall 28, and the lens is in one of its two extreme focus positions.

To realise the small change in curvature of the interface 44 needed to start movement of the slug 41, only a small voltage, e.g. only a few Volts, is needed so that voltage source is a low-voltage source. Because the movement start requires only a small change in curvature, the optical quality of the lens is hardly influenced by the movement.

During the downward movement of the slug 41 no voltage is applied between the sub-electrode 30 and the first electrode 34, i.e. electrode 30 is connected by switch 72 to the ground electrode 74. The hydrophobic layer at the position of electrode 30 remains hydrophobic. The downwards moving slug 41 presses the second fluid 50 at its lower side outside the chamber via the opening 37 in the chamber wall. A fluid guide 38 connected to this opening and the opening 36 at the upper side of the chamber guide the fluid 50 from the opening 37 to opening 36 where it re-enters the chamber.

FIG. 2b shows the second extreme state of the lens. This state has been reached by connecting the sub-electrode 30 to the second output 64 of the voltage source, via switch 72 and conductor 68, so that a low voltage is applied between the sub-electrode 30 and the first electrode 34. Electrowetting forces at the position of the sub-electrode 30 have caused a small change in the contact angle θ₁ of the interface 42 and a small change in the curvature of this interface such that it has become different from that interface 44. The difference between the surface tensions of the interface 42 and the interface 44 now have caused movement of slug 41 towards the sub-electrode. The voltage has been maintained until the slug has reached the position shown in FIG. 2b. During this movement no voltage is present between the sub-electrode 32 and the first electrode 34. The fluid 50 has been guided from opening 36 to opening 37 via fluid guide 38.

As shown in FIGS. 2a and 2b, the amount fluid 40 and the inner space of the fluid chamber are chosen such that always one of the interfaces 30, 32 is situated in the space portion enclosed by sub-electrode 30 and the other interface is situated in the space enclosed by sub-electrode 32. This always allows the activated electrode attracting the slug 41.

In the embodiment shown in FIGS. 2a and 2b wherein the fluid 50 is oil, there is a very thin oil film between the slug and the layer 48, which film acts as a lubricating film that east movement of the slug 41.

The low voltage required for driving the lens of FIGS. 2a and 2b allows lessening the requirements to be set to the fluids and selecting fluids, which show a considerably larger difference in their refractive index than fluids usually included in electrowetting lenses. The lens according to the invention therefor may have a considerably larger optical power than known electrowetting lenses.

The sub-electrodes form a cylinder of inner radius typically between 1 mm and 20 mm. These electrodes may be formed of a metallic material and be coated with successively an insulating layer and a hydrophobic layer or a single layer, which is both insulating and hydrophobic. This layer, 48 in FIGS. 2a and 2b has a thickness of between 5 nm and 50 μm.

FIG. 3 shows a second embodiment of the lens according to the Invention. With exception of the position of the electrode 34, this embodiment has the same construction as the embodiment shown in FIG. 2a. However in the embodiment of FIG. 3 a volume, or slug, of second fluid 50, for example oil, is arranged between two volumes of the first fluid 40, for example salted water. Seen from the slug, the interfaces 42′ and 44′ are concave. In this embodiment it is the oil slug that moves up and down in the cylinder upon activation of electrode 30 and 32, respectively. FIG. 3 shows the state of the lens at a moment at which the electrode 30 activation of electrode 30 has been finished or is still going on, i.e. electrode 30 is connected to the voltage source, so that the first fluid 40 has been, or is, sucked in the cylinder portion of this electrode and the second fluid has been, or is, replaced in the cylinder portion of the electrode 32. In order that the liquid 40 is always connected with the first output 62 of the voltage source 60, the electrode 34, also called counter electrode, preferably lead to one of the chamber openings 36 and 37 or the direct surrounding of these in the chamber wall where always fluid 40 is present. This is indicated in FIG. 3 by reference numeral 35.

FIG. 4 shows an embodiment of the lens wherein, instead of two cylindrical electrodes, a number of small annular electrodes 92 are used. The volume of first liquid 40, which shape for example approximates a sphere, and the height of the annular electrodes are chosen such that the slug of first liquid always is in the “field” of two neighbouring electrodes, 92n and 92n−1. Of these two electrodes one is activated and the other not. The construction of chamber 22 of the embodiment of FIG. 4 is the same as the construction of the previous embodiments so that further description of it is not necessary.

By switching from one annular electrode to the next one the slug will over a distance of one electrode up or down. Assumed that in the state shown in FIG. 4 electrode 92n is activated, i.e. a potential is applied to this electrode, activation of successively electrodes 92ₙ₋₁, 92ₙ₋₂ etc. the slug of first liquid 40 will move downwards, and upon activation of successively electrodes 92ₙ₊₁, 92ₙ₊₂ etc. the slug will move downwards. In this way the focus of the lens can be changed in small steps so that this embodiment is very suitable for use in zoom lens system.

Electronics circuits for switching a number of electrodes successively to a voltage source are well known in the art and adapting such a system for the lens of FIG. 4 is obvious for the person skilled in the art.

Similar as in the embodiment of FIG. 3, also in the embodiment of FIG. 4 the liquids may be interchanged, i.e. a slug of second liquid 50, for example oil, may be arranged between two volumes of first liquid 40. Preferably, the counter electrode 34, not shown in FIG. 4 is then arranged in one of the openings 36 or 37 of the chamber.

It will be appreciated that the above embodiments are provided by way of example only and that various alternative designs will fall within the scope of the present invention.

For instance, in the above embodiments, it has been assumed that the chamber defined by wall 24 has a circular cross-section. However it will be appreciated that the chamber can in fact have any desired cross-section i.e. square, rectangular, circular or ellipsoidal.

The variable lens according to the invention may be very compact and thus is very suitable for use in a miniature camera. The optical principle of such a camera is shown in FIG. 5. Camera 100 comprises an objective lens system 102 having an optical axis 104 and an image receiving unit 112 which receives the image formed by the lens system 102 of a scene or object at the left hand side of the lens system. The unit 112 may be an opto-electronic sensor such as a CCD or CMOS sensor, but also a photographic film. The camera may be a still picture camera or a video camera. The lens system may be a variable lens as described herein above with reference to FIGS. 2a and 2b and FIG. 3 and thus comprises a liquid chamber 102 including a slug of a first fluid 108 between two volumes of a second fluid 110. As described herein before this lens may have a large power and its focus can be changed by means of low voltages applied between its electrodes. The camera lens system may comprise additional lens elements, which may be integrated with the variable lens.

FIG. 6 shows an example of a hand-held apparatus wherein a camera, wherein the present invention is implemented, is included. The apparatus is a mobile phone 120, which is shown in a front view in FIG. 6. The mobile phone has a microphone 122, which inputs the user's voice as data, a loudspeaker 124, which outputs the voice of a communicating partner, and an antenna 126, which transmits and receives the communication waves. The mobile phone further comprises an input dial 128, by means of which the user inputs information such as a phone number to be dialed and a display 130, for example a liquid crystal display panel. This panel may be used to display a photograph of the user's communicating partner or to display data and graphics. For processing the input data and the received data, a data processing unit (not shown) is included in the mobile phone.

The mobile phone is provided with a miniature camera 132, comprising a variable lens as described herein before with respect to FIGS. 2a and 2b and FIG. 3. Of this front camera only the front surface is shown in FIG. 6. The elements of the camera such as the liquid chamber, possibly other lens elements and the image sensor may be arranged along a line perpendicular to the front surface of the phone i.e. in the direction perpendicular to the plane of drawing of FIG. 6, if the dimension of the mobile phone in this direction is large enough. Alternatively, the camera may be provided with one or more folding mirror(s) so that a substantial portion of the optical path of the camera can be arranged parallel to the front surface of the mobile phone, which then may be relatively thin.

Usually, the lens in a miniature camera for a mobile phone has a fixed focus and is of the Tele type, which means that this lens forms a sharp image on the sensor of an object or scene, which is at a large distance from the camera. By including the simplest embodiment of the variable lens shown in FIGS. 2a and 2b or FIG. 3 the camera can be switched between Tele mode and Macro mode so that also objects or scenes at a short distance from the camera can be sharply imaged on the sensor.

Especially if the embodiment of the variable lens with a series of ring shaped electrodes, as shown in FIG. 4, is included in the mobile phone camera, this miniature camera can be upgraded from a fixed focus camera to a zoom camera. Since this lens may have large optical power and requires only a very small drive voltage, it is very attractive for this application.

Zooming is understood to mean changing the image scale; i.e. selecting the size of the object scene that is imaged, by changing the focal distance of the zoom lens. The extreme settings of a zoom lens are Tele mode, wherein a small portion of the object scene is imaged. The variable lens shown in FIG. 4 can perform the zoom function i.e. change the focal distance from Tele to Wide and any setting between these two. Usually in a zoom lens a second function, the focusing function, should be performed. Focusing is understood to mean keeping the portion of the object scene zoomed at in focus for every zoom state. For performing the focus function the zoom lens system should comprise a second variable lens. Conventionally the latter lens is a movable solid lens. According to the invention also lens can be replaced by variable lens as described herein before.

The present variable lens can also be used in lens systems other than zoom lens systems

Other hand-held apparatus wherein a variable lens according to the invention may be used are, for example, a personal digital assistant (PDA), a pocket computer and an electronic toy, wherein miniature cameras are built in.

The invention may also be implemented in non-built-in cameras, like Web cameras, cameras for intercom systems and pocket-sized and other-sized cameras, for example digital cameras. For the invention it is irrelevant whether the camera uses a film or an electronic sensor.

The variable lens can also be used in a device 160 for scanning an optical record carrier 150 as shown in FIG. 7. The record carrier comprises a transparent layer 152, on one side of which an information layer 154 is arranged. The side of the information layer facing away from the transparent layer is protected from environmental influences by a protection layer 156. The side of the transparent layer 152 facing the device 160 is called the entrance face 158. The transparent layer 152, acts as a substrate for the record carrier by providing mechanical support for the information layer.

Alternatively the transparent layer 152 may have the sole function of protecting the information layer 154, while the mechanical support is provided by a layer on the other side of the information layer, for instance by the protection layer 156 or by a further information layer and a transparent layer connected to the information 154.

Information may be stored in the information layer 154 of the record carrier in the form of optically detectable marks arranged in substantially parallel, concentric or spiral tracks, not indicated in the Figure. The marks may be in any optical readable form, e.g. in the form of pits, or areas with a reflection coefficient or a direction of magnetisation different from their surroundings, or a combination of these forms.

The scanning device 160 comprises a radiation source 162 that can emit a radiation beam 164. Preferably, the radiation source is a semiconductor laser, or diode laser. A beam splitter 166 reflects the diverging beam 164 towards a collimator lens 168, which converts the diverging beam 164 into a collimated beam 170. The collimated beam 170 is incident on an objective lens system 174, which is represented here as a single lens element, but may comprise several lens elements and/or a grating. The objective system 174 has an optical axis 176.

The objective system 172 changes the collimated beam 170 into a converging beam 172, which is incident on the entrance face 158 of the record carrier. The objective system has a spherical aberration correction adapted for passage of the radiation beam through the thickness of the transparent layer 152. The converging beam 172 forms a scanning spot 178 in the in formation layer 154. By rotating a disc-shaped record carrier around a central axis parallel to the plane of the drawing of FIG. 7 an information track is scanned, i.e. read or provided with data. By moving the scanning spot in the radial direction, all tracks in the information layer can be scanned.

Scanning beam radiation reflected by the information layer 154 forms a divergent beam 180. This beam is transformed into a substantially collimated beam 182 by the objective system 174 and subsequently into a converging beam 184 by the collimator lens 168. The beam splitter 166 separates the reflected beam from the beam towards the record carrier by transmitting at least a part of the converging beam 184 towards a radiation-sensitive detection system 186. The detection system 186 captures the radiation of beam 184 and converts it into electrical output signals 188. A signal processor 190 converts these output signals to various other signals.

One of the signals is an information signal 192, the value of which represents information read from the information layer 154. An information-processing unit for error correction 194 processes the information signal. Other signals from the signal processor 190 are a focus error signal and a tracking error signal. The focus error signal represents the axial difference in height between the spot 178 and the information layer 154. The tracking error signal represents the distance, in the plane of the information layer 154, between the spot 178 and the centre of a track in the information layer to be followed by the spot. The focus error signal and the tracking error signal are fed into a servo circuit 198, which converts these signals to servo control signals 200 for controlling a focus actuator and a tracking actuator, respectively. These actuators are not shown in FIG. 7. The focus actuator controls the position of the objective system 174 in the focus direction 202, thereby controlling the actual position of the spot 178 so that it coincides substantially with the plane of the information layer 154. The tracking actuator controls the position of the spot with respect to the track to be scanned, for example by controlling the position of the objective system 174 transverse to the track direction such that the centre of the spot coincides substantially with the centre line of the track. In FIG. 7 the tracks run in a direction perpendicular to the plane of drawing.

Currently, data can be stored in information layers of optical record carriers having different formats, such as compact discs (CDs), digital versatile discs (DVDs) and Blu-Ray™ discs. To avoid customers have to purchase different devices for reading and/or writing data from different format discs it is desirable for a single scanning device to be capable of scanning optical record discs of different formats. This scanning device, also called combi-player should have different characteristics for the different formats. For example CDs are designed to be scanned with a laser beam having a wavelength of about 785 nm and a numerical aperture (NA) of 0.45. DVDs on the other hand are designed to be scanned with a laser beam having a wavelength in the region of 650 nm and a numerical aperture of 0.6. Blu-Ray™ discs should be scanned with a laser beam having a wavelength of about 405 nm and a numerical aperture of 0.85. A device capable of scanning optical discs of different formats should comprise a radiation source which can emit laser beams of the required different wavelengths and its objective system should be variable and adaptable to the different wavelengths and the different thickness of the transparent layers 152 of these discs. Also the NA of the converging beam 172 should be adaptable to the disc format. The variable lens described herein before can advantageously be used in an objective system of a combi player to adapt this objective system to the focus and/or spherical aberration correction required for the different format discs to be scanned by beams of different wavelengths.

For instance in a dual layer Blu-Ray™ disc, the two information layers are at depths of 0.1 mm and 0.08 mm, thus separated by typically 0.02 mm. When the laser beam of a specific wavelength λ is refocused to go from one layer to the other layer, due to the difference in information layer depth, some 200 mλ of unwanted spherical aberration arise, which need to be compensated. This can be achieved by introducing opposite spherical aberration into the objective system 174, such that the spherical aberrations cancel out.

In an embodiment of the scanning device wherein the invention is implemented spherical aberration is introduced into the objective system 174 by altering the degree of collimation of the beam 170 incident upon the objective system 174, by using a variable lens in accordance with the present invention. Such a variable lens can be incorporated as an extra element within the optical path of the beam 164, or the variable lens can form part of the collimator lens 168, e.g. lens 168 is a compound lens. By varying the position of the menisci within the variable lens, the beam 164 can varied from being parallel to be slightly converging or diverging as required, so as to introduce the required spherical aberration.

1. A variable lens comprising:
a substantial cylindrical fluid chamber (22) including a first, electrically conductive, fluid (40) and a second, non-conductive, fluid (50), the fluids being non-miscible, in contact with each other and having different indices of refraction, and
an electrode configuration comprising a first electrode (34) in contact with the first fluid (40) and second electrode means (30,32; 92) arranged at the chamber wall (24), characterized in that
a volume of one of the fluids (40) is arranged between two volumes of the other fluid (50), in that
the second electrode means comprises at least two sub-electrodes (30,32; 92) each covering, in the direction of the cylinder axis, different portions of the cylinder wall and in that
the chamber wall is provided with two openings (36,37) at its opposite ends which openings are interconnected by means of an external fluid guide (38) to circulate one of the fluids in and out the chamber.

2. A variable lens as claimed in claim 1, characterized in that the inner wall of the fluid chamber facing the fluids is covered with an insulating layer (48).

3. A variable lens as claimed in claim 2, characterized in that the insulating layer (48) is hydrophobic.

4. A variable lens as claimed in claim 1, characterized in that a volume of the first fluid (40) is arranged between volumes of second fluid (50).

5. A variable lens as claimed in claim 1, characterized in that a volume of the second fluid (50) is arranged between volumes of the first fluid (40).

6. A variable lens as claimed in claim 5, characterized in that the first electrode (34) is arranged substantially in one of the openings (36; 37) in the chamber wall (24).

7. A variable lens (90) as claimed in claim 1, characterized in that the second electrode means comprises a series of annular electrodes (92).

8. A variable lens as claimed in claim 1 in that the fluids (40,50) are liquids.

9. A variable lens as claimed in claim 8, characterized in that the first liquid (40) is salted water and the second liquid (50) is oil.

10. A variable lens as claimed in claim 1, wherein the lens (20) is a zoom lens.

11. An image-capturing device (100) comprising a lens system (102) and an image-receiving unit (112), characterized in that the lens system (102) comprises a variable lens as claimed in claim 1.

12. A camera comprising an image-capturing device (100) as claimed in claim 11.

13. A camera as claimed in claim 12, wherein the lens system (102) is a zoom lens system.

14. A hand-held apparatus (120) comprising a camera as claimed in claim 12.

15. A hand-held apparatus wherein the apparatus is a mobile phone (120).

16. An optical device (160) for scanning an information layer (154) and comprising a radiation source unit (162) for supplying a scanning beam (164, 170,172) an optical lens system (168,172) for focusing the scanning beam to a scanning spot (178) in the information layer and a radiation-sensitive detection unit (186) for converting scanning beam radiation from the information layer in electrical signals (188), characterized in that the lens system comprises a variable lens (20; 80; 90) as claimed in claim 1.

17. An optical device as claimed in claim 16 for scanning at least two information layers (154) at different depths in one record carrier 9150) and comprising an objective lens system (174) and a collimator lens system (172), characterized in that the variable lens (20; 80) is included in the collimator lens system to correct for spherical aberrations introduced by the different depths of the information layers.

18. An optical device as claimed in claim 16 for scanning at least two information layers (154) of different format, wherein the radiation source unit (162) is switchable to emit at least two beams (164) of different wavelengths and wherein the lens system comprises an objective lens system (174), characterized in that the variable lens (20; 80; 90) is included in the objective lens system (174) to adapt this system for the different formats of the information layers (154).
